(19) United States
(12) Patent Application Publication
(10) Pub. No.: US 2008/0162196 A1
(43) Pub. Date: Jul. 3, 2008

(54) SYSTEM AND METHOD FOR CENTRALIZING AND PROCESSING TICKET EXCHANGE INFORMATION

(75) Inventors: Diego Espinosa, Phoenix, AZ (US); Krista S. Freiland, Phoenix, AZ (US); Satyendra S. Hiredesai, Phoenix, AZ (US); Tovah L. Licht, Scottsdale, AZ (US); Kim Mennemeyer, Rochester, NY (US); Vladimir N. Shatalin, Cranbury, NJ (US)

Correspondence Address: FITZPATRICK CELLA (AMEX), 30 ROCKEFELLER PLAZA, NEW YORK, NY, 10112, US

(73) Assignee: AMERICAN EXPRESS TRAVEL SERVICES, CO., INC., New York, NY (US)

(21) Appl. No.: 11/617,922

(22) Filed: Dec. 29, 2006

(51) Int. Cl. G06Q 10/00

(52) U.S. Cl. 705/5

(57) ABSTRACT

Method and system for identifying and consolidating information related to unused airline tickets. The information is retrieved from a global distribution system (GDS) and consolidated in a database of the booking agent, giving the booking agent automatic access to the information when there is an option to exchange the unused ticket for a new ticket.

### RELATED APPLICATIONS

This application is related to application Ser. No. 10/708,112, Ser. No. 10/294,930, Ser. No. 09/346,085, 60/396,224, and an application entitled System and Method for Redemption and Exchange of Unused Tickets, filed on the same date as this application. Those applications are hereby incorporated herein by reference in their entirety.

### BACKGROUND OF THE INVENTION

1. Field of the Invention

The present invention generally relates to a system, method, and computer program for providing a centralized repository of information pertaining to unused, non-refundable tickets, from airlines and the like, for use in identifying when the residual value of such tickets can be exchanged/redeemed for new tickets. More particularly, the invention generally relates to providing a centralized repository which enables a travel service to track the unused, non-refundable tickets of its clients in an efficient manner, such that the system will identify any unused tickets that potentially can be exchanged or redeemed for a new ticket, when the customer contacts the travel service to book a new ticket.

2. Related Art

Often tickets purchased for airline flights, or the like, are canceled in advance of the scheduled flight. This is quite common in connection with business travel, when a planned trip is canceled altogether or the business traveler must fly to another destination rather than using the return leg of a trip. Consequently, all or part of a ticket may go unused. Increasingly, tickets issued by airlines are non-refundable. Thus, the traveler or corporation cannot obtain a monetary refund for the unused legs of the trip. Typically, however, the ticket can be exchanged, within a predetermined period (e.g., one year). Specifically, while not refunding the purchase price, the airline may allow the residual value of the unused ticket to be applied to another flight.

In typical situations, the residual value of the unused ticket can be redeemed for up to one year from the date of the original trip, and subject to rules and penalties that may be associated with the original ticket. Problems arise, however, in that the customer or the customer's travel service must be vigilant in future bookings to ensure that the value of the unused ticket is applied when possible. This poses a significant problem for the customers and their booking services. To begin, either the customer or the travel service must be aware of the existence of the unused ticket. Even if the customer recalls that there is an unused ticket, the identifying information for that ticket must be available. If the details of the ticket cannot be recalled, a booking agent could be forced to check each global distribution system (GDS) (use to describe ticket issuing services through which airlines issue tickets to booking services) for records of the ticket, because typically only the GDS that issued the ticket will have the records. Even if the identifying information is available, so that the booking agent knows the GDS at which the ticket records may be found, retrieving the records from GDS can be tedious and time consuming. Also, even if the record can be located, the rules and restrictions for the unused ticket must be properly analyzed to determine the residual value of the ticket and whether that residual value can be applied to the new ticket.

Consequently, ticket exchanges can be arduous. If a client calls to book a new ticket, and only remembers vague details of an unused ticket, identifying the ticket and determining whether it can be exchanged for the new ticket could take 20 minutes or longer. That amount of time is typically not reasonable for a client to spend on the telephone during the booking process. And this situation assumes that the client recalls the existence of the unused ticket. Not surprisingly, the rate of actual exchanges (as opposed to letting the unused ticket expire) can be as low as 10%. A more detailed discussion of the exchange process is provided below.

Conventionally, when a travel service (or other booking services or individual) purchases an airline ticket for a customer, the service makes the arrangement through one of various GDSs. Traditionally, a GDS was a service (implemented through a computer system) specific to an airline, which system was used to issue tickets for the customer. In most cases, GDSs are no longer airline specific, and may be used for booking tickets through any one of a specific selection of airlines. Examples of GDSs are Sabre Airline Solutions™, Apollo Focalpoint™, and WorldSpan™. The booking service uses one of these resources to book a ticket, and the GDS issues the ticket (or electronic ticket record (ETR), which is the ticket image for e-tickets) and prepares a passenger name record (PNR). The PNR and ETR are recorded at the GDS, such that the booking service can later access the information at the GDS. For paper tickets, typically only a PNR is recorded.

The PNR contains information about the itinerary and restrictions for the ticket; however, the PNR may expire (e.g., be purged) from the GDS records after a prescribed period, typically 90 days. If the PNR expires, the system should still have the ETR, for e-tickets, or a PNR history (which is generally created at the time of the PNR and also includes details of the ticket). These records, stored at the GDS, are the official record of the details of the ticket. If the ticket goes unused, and a customer wishes to exchange the ticket at a later date, that ticket information will be necessary to establish the residual value of the ticket and to review the restrictions (e.g., the applicability of the unused ticket to the new ticket).

Typically, there is more ticket information recorded in the GDS than provided on the paper ticket or with the image of the e-ticket. Thus, it is imperative that the travel service be able to locate the information in the GDS system to perform a ticket exchange. So, not only must the travel service or customer be aware of the existence of an unused ticket, but the details of record of the ticket must be identified. Identifying this information can be time consuming inasmuch as the travel service must first identify at which GDS the ticket information is located, and then locate the PNR, or PNR history, if the PNR has already been purged. Moreover, once the ticket information is retrieved, the travel service must determine the residual value of the ticket and interpret and restrictions that may prevent the residual value from being applied to a new ticket. Typically, the restrictions are recorded in the PNR in a format that requires interpretation by an experienced travel agent.

Given the possibility that the existence of the unused ticket can be overlooked or forgotten, and the difficulty of identifying and applying the unused ticket to a new purchase, it is not surprising that many unused tickets expire without being applied to other ticket purchases. The expiration of these tickets represents a significant financial loss for the traveler or the traveler's employer.

Conventionally, there has been no centralized system for addressing this problem to avoid the waste associated with the expiration of unused tickets. Some travel services, or individual agents at travel services, attempt to keep track of unused tickets. Typically, this involves handwritten notes, computer spreadsheets, word processing documents with lists of unused tickets, access databases for local use, and the like. These options, however, are minimally effective. In addition, some GDSs offer rules engines for deciphering the restrictions for an unused ticket. Unfortunately, such an engine is typically only useful once the record of the ticket has been retrieved. Also, it should be appreciated that each GDS may have its own format for ticket records and listing of restrictions, making the interpretation of the same difficult and limiting the use of the known search engines across different systems.

To date, there has not been an effective and coherent solution to the problem of monitoring and exchanging unused, nonrefundable tickets. Given the foregoing, there is a great need for a system, method, and computer program product that identifies, monitors, and provides timely and seamless access to records of unused tickets, so that the customer and/or agent can determine the usefulness of the same when booking new travel plans. The present invention provides a solution to the problem.

The details of the invention will be discussed below. While the invention will be described with respect to airline tickets, it will be appreciated by one of ordinary skill in the relevant art(s) that the invention can be applied to the tracking of tickets or records other than for airlines. Specifically, the invention can be used for reservations or tickets for other forms of travel, hotel reservations, concerts, seminars, shows, park admissions, events, and the like.

### BRIEF DESCRIPTION OF THE INVENTION

The present invention meets the above-identified needs by providing a system, method and computer program product for recording, centralizing, and monitoring ticket exchange information.

An advantage of the present invention is that it allows a ticketing service to identify and consolidate information on unused tickets. Specifically, the ticketing service receives a request from a client to cancel a ticket, and processes the request. To maintain accurate records of the unused ticket, the invention extracts, from a record of the canceled ticket, data indicative of details of the canceled ticket including, for example, client identification information and ticket source identification information. That data is then stored in an electronic database. Preferably, the database is linked to an electronic booking tool used by the ticketing service to process client requests, such that, when a record of the client is retrieved using the electronic booking tool, existence of the canceled ticket is identified to a user.

Another advantage of the present invention is that the canceled ticket may be flagged for further processing at a global distribution system. Consequently, the extraction of data may involve a computer of the booking agent automatically (i) contacting the global distribution system; (ii) identifying the flagged, canceled ticket; (iii) retrieving at least one record of the ticket from the global distribution system; and (iv) parsing data from the record of the ticket. The parsed data may be stored in a database separate from the global distribution system, preferably on the ticketing service side.

Another advantage of the present invention is that the processing of the client's request may include (i) accessing a record of the ticket at a global distribution system; and (ii) providing in the record of the ticket, at the global distribution system, information concerning the processing to be performed during the extraction and information concerning details of the ticket. This may prove useful for paper tickets that require data entry in the GDS to assist in later parsing. Consequently, the extraction preferably includes (i) contacting the global distribution system; (ii) accessing the record of the ticket in the global distribution system; and (iii) parsing data from the record of the ticket based on the information provided therein by the invention. The parsed data is stored in a database separate from the global distribution system.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary ticketing system in which the present invention, in an embodiment, would be implemented.

FIG. 2 is a flowchart illustrating a ticket cancellation and tracking process according to one embodiment of the present invention.

FIG. 3 is a block diagram of an exemplary computer system useful for implementing the present invention.

FIG. 4 is an example of the remarks portion of a passenger name record used in the present invention.

FIG. 5 is an example of a portion of an electronic ticket record used in the present invention.

### DETAILED DESCRIPTION

### I. Overview

The present invention is directed to a system, method and computer program product for recording, centralizing, and monitoring ticket exchange information. The present invention is now described in more detail herein in terms of the above exemplary unused ticket exchange system and method. This is for convenience only and is not intended to limit the application of the present invention. In fact, after reading the following description, it will be apparent to one skilled in the relevant art(s) how to implement the following invention in alternative embodiments. Specifically, while the present invention is discussed generally with respect to airline ticketing systems, one of ordinary skill in the relevant arts will appreciate that the invention can be used with other ticketing or voucher systems.

The terms “user,” “end user,” “consumer,” “customer,” “client,” “passenger,” and/or the plural form of these terms are used interchangeably throughout herein to refer to those persons or entities capable of accessing, using, being affected by and/or benefiting from the tool that the present invention provides for recording, centralizing, and monitoring ticket exchange information, or their agents/representatives.

The terms “travel service,” “travel agent,” “booking agent,” “booking service,” “ticketing agent,” “ticketing service,” and/or the plural form of these terms are used interchangeably throughout herein to refer to those persons or entities which use the tool to provide the service enabled by the present invention to the customer.

The terms “mark” and “flag” are used herein to refer to the identifying of a record of the like for future reference. Such marking or flagging can take place by placing identifying information in the record, or in records or systems separate from the marked record. In their broadest meaning, those terms refer to identifying a record or file for further processing or other action.

The terms “identifying,” “accessing,” “retrieving,” “reading,” and the like are used throughout herein, often interchangeably, to refer to the locating, obtaining, downloading, reviewing, reading, or accessing data stored in records or elsewhere (usually electronically), and are intended to be interpreted broadly to cover any one of such activities, unless otherwise defined.

The terms “ticketing,” “booking,” “issuing,” and “reserving” are used interchangeably throughout herein to refer to the process of obtaining and/or reserving a ticket for a customer. The term “ticket source” is used to refer to the entity issuing the ticket (e.g., airline, GDS, or the like).

The term “Global Distribution System” or “GDS” refers to various systems which are used by booking agents to book airline tickets for customer; however, as used herein, the terms should be interpreted broadly to encompass services used in connection with booking tickets, coupons, vouchers, and the like for any one a number of means of travel, events, shows, accommodations, and the like, rather than just airline bookings.

### II. System

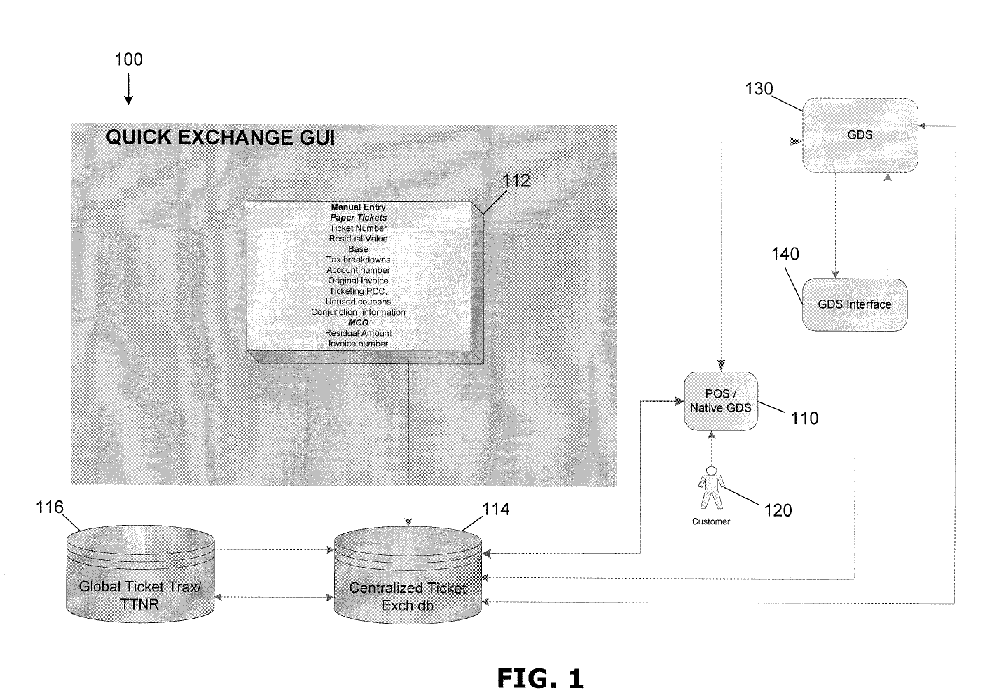

FIG. 1 shows a system diagram of an exemplary ticketing system 100 in which the present invention, in an embodiment, would be implemented.

System 100 includes a point-of-sale (POS) tool 110, exchange graphical user interface (exchange GUI) 112, centralized ticket exchange database 114, and forgotten ticket locator system 116. Also shown in FIG. 1 is a GDS 130 and GDS interface 140 (which can be any utility or transparent usage program for enabling use of the GDS). Those items are not listed as part of system 100 inasmuch as, in this embodiment, they are not part of the booking service, but are outside components/systems.

The POS tool 110 is a computer interface that allows a booking agent to obtain airline tickets for a customer, and may be/include native GDS scripts used in the airline industry. The interface allows the booking agent to communicate with a GDS 130 to secure a travel reservation and issue a ticket for the customer. The same POS tool 110 is used to communicate with the GDS 130 when the customer 120 instructs the booking agent to cancel the ticket. While in most cases, a booking agent will use the POS tool 110 for the customer 120, it will be appreciated by one of ordinary skill in the relevant art(s) that the POS tool 110 can be a program, such as a web-based program, that the customer 120 accesses on his own, directly, without the aid of a live booking agent.

In the case of canceling a non-refundable ticket, the customer 130 cannot receive a refund of the ticket price, but in some circumstance the value of the canceled ticket can be applied to a future ticket. To apply the residual value to the future ticket, the travel agent and/or customer must be able to identify the unused ticket at the time of booking the new ticket, and be aware of the residual value of the unused ticket, the airline (or airlines) at which it may be used, the expiration date of the ticket, the GDS through which the ticket was booked, restriction on the application of the unused ticket to future fares, etc. Ticket exchange database 114 provides a centralized system for storing such information and making it readily available when the customer attempts to book a new ticket to which the residual value of the unused ticket can be applied.

In the preferred embodiment, POS tool 110 is used to access the GDS 130 at which the ticket was booked, and cancel the ticket. Preferably, POS tool 110 is used to place the canceled ticket in a GDS queue for later processing, in connection with the cancellation. The POS tool 110 may provide additional information in the ticket records of GDS 130, in order to facilitate the later processing. A GDS interface 140 (in a preferred embodiment, this includes both an interface and a canceled ticket processor (e.g., a utility or the like)) allows the system 100, using various robotic jobs, to access GDS 130 and identify the unused ticket from the GDS queue and extract therefrom information for exchange database 114. More preferably, another GDS interface is provided between exchange database 114 and GDS 130 to allow the database 114 to access GDS 130. In a preferred embodiment, exchange database 114 is connected to POS tool 110, such that, when the customer next attempts to book a new ticket, the POS tool 110 automatically alerts the user of POS tool 110 to the existence of the unused ticket, the value of which may be applied to the new ticket.

With the system described above, the system 100 can later retrieve from the outside system (GDS 130) data necessary to keep track of the unused ticket. The data is preferably retrieved from GDS 130 after cancellation by the booking agent because GDS 130 provides a useful place from which to retrieve data using robotic processes. Furthermore, when additional data needs to be provided at the time of canceling the ticket, GDS 130 provides useful means to enter and store the data, for later retrieval.

In other embodiments, however, data concerning the unused ticket can be entered directly into the exchange database 114, using exchange GUI 112. Examples of information that may be entered include the ticket number, residual value, base fare, tax breakdowns, account number, ticketing PCC (security measures), unused coupons, conjunction information (for tickets with more than four legs), miscellaneous charge order (MCO), residual amount, invoice number, etc. The exchange GUI can be used in addition to or in lieu of entering the data in the records of GDS 130. Also, if all of the necessary information is entered using the exchange GUI, system 100 will not later have to access GDS 130 to extract any additional information. In other embodiments, there can be a hybrid system in which some data is entered directly into ticket exchange database 114 using exchange GUI 112, and other information is extracted from GDS 130. The division of work can be designated based on design considerations and ease of use. It is preferable that that the booking agent be burdened as little as possible with data entry, to same time and effort. The use of robotic jobs to retrieve the necessary information from the GDS 130 is one way to achieve that end.

Forgotten ticket locator system 116 is a tool that contacts GDS 130 and looks for unused tickets which were originally booked by the booking agent, but which were subsequently canceled through a channel other than the booking agent. Since the booking agent that booked the ticket did not cancel the ticket, the booking agent's computer system 100 would not have a record of the unused ticket in exchange database 114. Locator system 116 queries GDS 130 and mines/searches the records for tickets which remain unused past the scheduled date of travel. When such tickets are identified, locator system 116 updates ticket exchange database 114 to reflect the unused ticket, even though the ticket was not canceled using POS tool 110. An example of such a locator system is Global Ticket Trax.

As can be appreciated from the elements shown in FIG. 1, in a preferred embodiment, system 100 operates to gather unused ticket information and store the same on the booking agent side, rather than the GDS side, so that the booking agent has automatic/direct access to pertinent information concerning the unused ticket when the customer is making a new booking or inquiring as to his account and past tickets. This significantly reduces the burdens previously associated with identifying and tracking unused tickets for customers and provides the booking agent and customer with the relevant information quickly and easily.

### III. Process

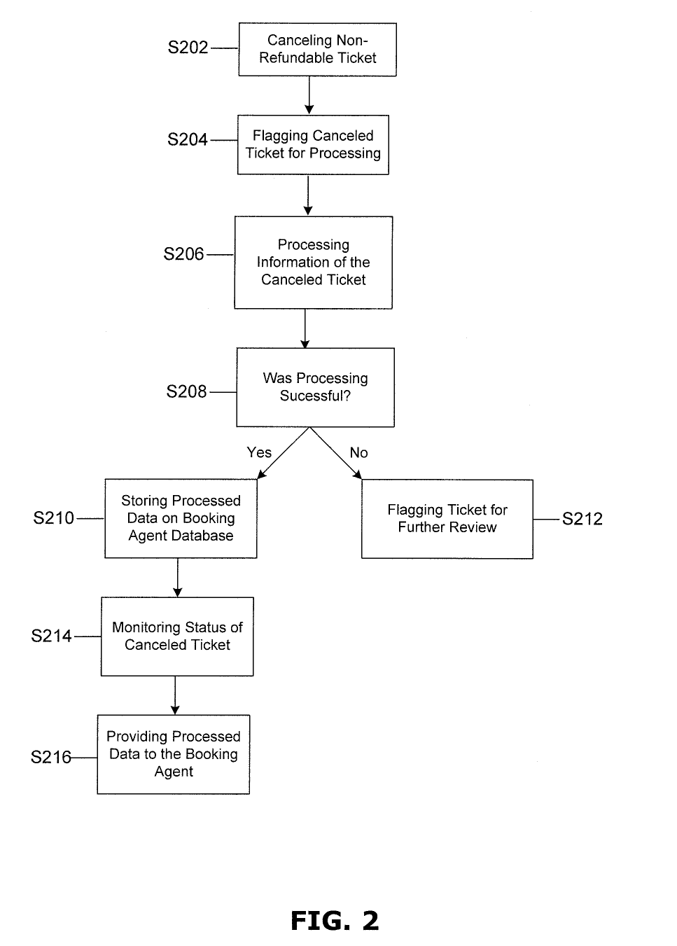

FIG. 2 shows a flowchart illustrating a ticket booking/exchange process 200, according to one embodiment of the present invention.

Process 200 begins at step 202 in which a customer cancels a non-refundable airline ticket and does not rebook the travel plans at that time. The cancellation is typically achieved by the customer (normally the actual passenger under whose name the ticket is booked, or representative of the passenger) contacting the booking agent and asking the booking agent to cancel the ticket. This is typically done in advance of the scheduled departure, so that the ticket can be preserved and later redeemed, if possible.

The booking agent identifies the ticket using a POS tool which allows the booking agent to access the computer systems of the GDS through which the ticket was booked. The GDS system includes a PNR for the ticket and, for electronic tickets, an ETR. Using the POS tool, the booking agent updates the GDS system to reflect the cancellation of the ticket.

As will be appreciated, the booking agent can be a live person who utilizes the POS tool for the customer. Alternatively, the system can be automated such that the customer accesses the booking service through a web page, or the like, and is directed to provide information that allows the system to attend to the cancellation without the assistance of a live operator. Thus, while the actions of a booking agent or service will be discussed below, the same processes can be performed by automated computer routines, in which case the booking agent can be interpreted as the interface through which the customer makes the request.

In addition to canceling the ticket, the invention involves allowing for the storing of data concerning the cancellation so that the unused ticket can be easily identified at a later date.

In step 204, the canceled ticket is flagged for further processing. The booking agent typically flags the ticket for further processing by placing the ticket identification information in a GDS queue, and adds notations to the remarks section of the PNR record which indicate the processing to be performed on the ticket information. Alternatively, the flagging can involve identifying the ticket number (or other identification information) at the booking service side, to that robotic processes which later access the GDS know in advance the identity of the ticket and processing to be performed.

Step 204 can be completely performed at the discretion of a live booking agent, or the agent can be prompted to perform certain tasks when the POS tool recognizes that a ticket is being canceled. Of course, the whole process can be automated. Similarly, the information added to the PNR (or recorded at the booking service system) can be input by the booking agent, automatically inserted by a computer routine, or some combination thereof. Thus, in a preferred embodiment the information concerning the identity of the canceled ticket to be processed and the processing to be performed are stored, preferably in the ticket records at the GDS.

In step 206, the ticket information for the canceled ticket, stored at the GDS, is accessed and processed. Preferably, this step is performed by a robotic job (e.g., automated computer process) stored and controlled at a computer system on the booking service side. In a preferred embodiment, the robotic job accesses the GDS system periodically (preferably every few hours) and performs necessary tasks on tickets identified for processing in the GDS queue. The robotic job may retrieve the tickets identified in the queue and search the PNR (or other ticket records) for remarks that instructs the robotic job on the exact processing to be performed, if such instructions have not been previously provided. In the case of canceled tickets, the necessary information for processing the data preferably was entered in the PNR in step 204.

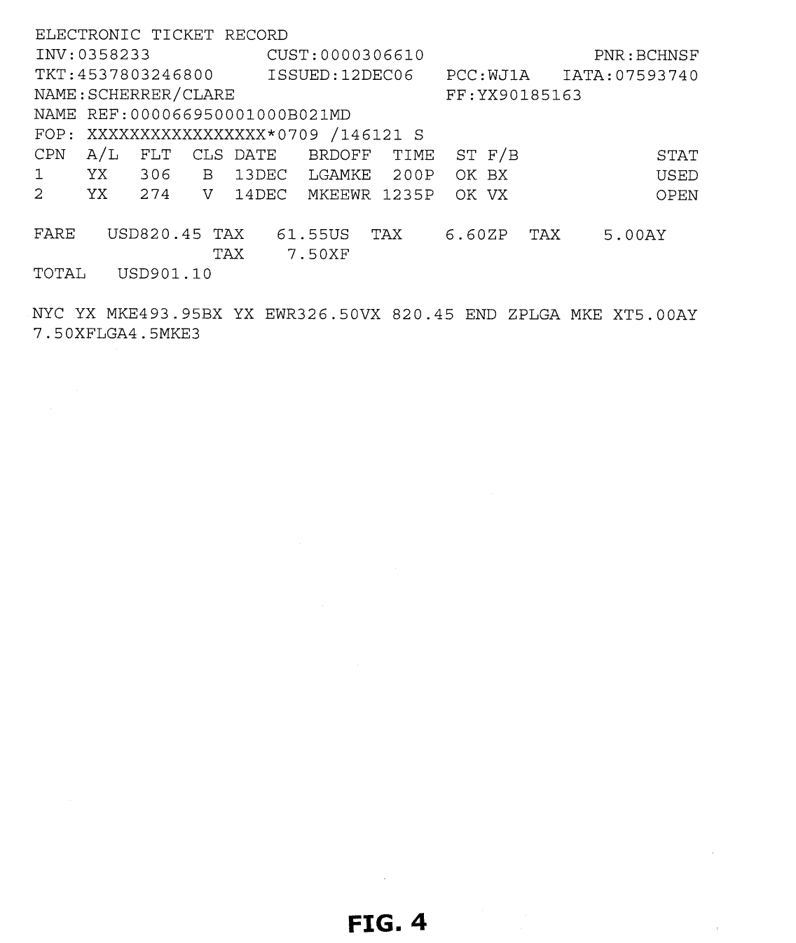

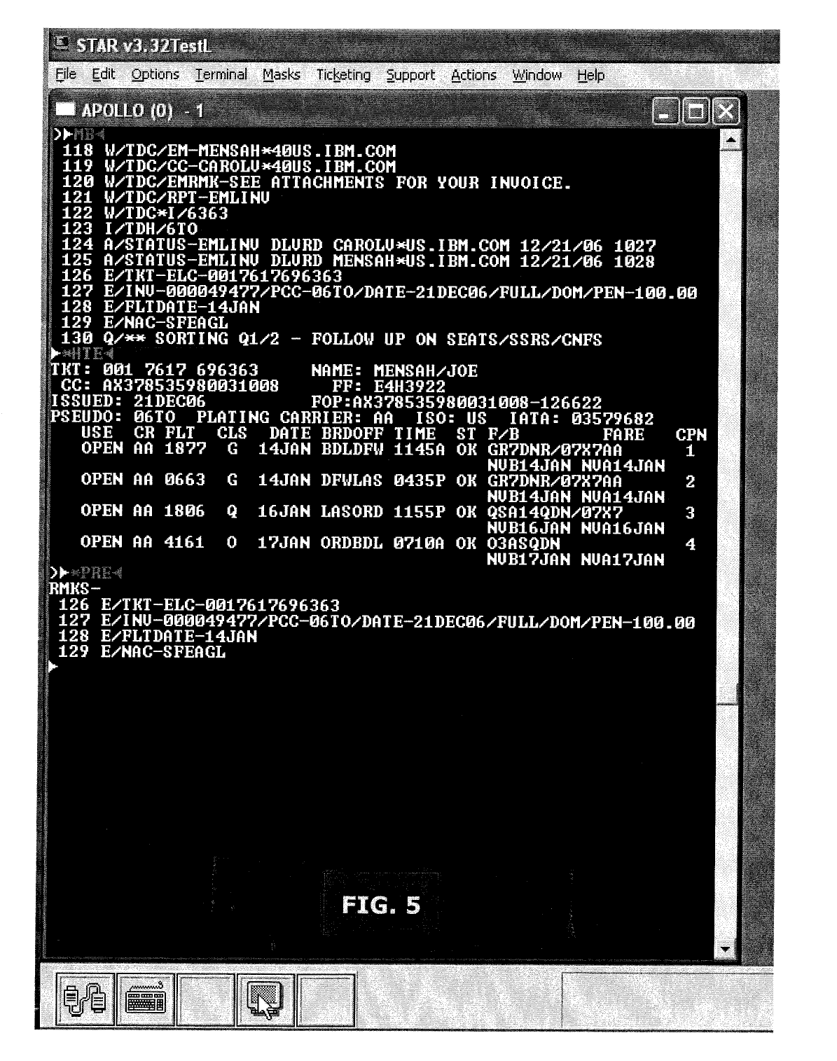

In preferred embodiments, the processing performed involves parsing ticket information from the ticket records of the GDS system. Preferably, these records include the PNR and the ETR. FIG. 4 shows an example PNR. In that figure, 402 identifies the remarks section of the PNR. FIG. 5 depicts an example ETR.

The robotic job includes software that can read these records in the GDS and retrieve the necessary information. In this regard, different GDSs may have different record formats. The robotic job, therefore, may operate differently for different GDSs, so as to parse the information properly. One of ordinary skill in the relevant art(s) will appreciate that any one of a number of computer programs can be written to implement the robotic jobs used in this method.

Examples of information retrieved from the ticket records may include processing instructions input by the booking service, the ticket number, passenger name (or other passenger identification information), residual value of the ticket, base fare, tax breakdowns, account numbers, GDS identity, original invoice, ticketing PCC, unused coupons, conjunction information, MCO, residual amount, invoice number, rules and restrictions governing the ticket, where the ticket issued, date of the flight, date of the invoice, among other information. This information is parsed and analyzed.

The analysis can take any one of a number of forms, and involve sub-steps. For instance, the robotic job can analyze the format and language of the rules and restrictions so as to determine, given the airline, the limitations on the use of the ticket for exchange purposes. While programs for performing this task can be written specifically for the system, existing programs are also available for reading and interpreting ticket restrictions.

In addition, the residual value of the ticket may need to be calculated, particularly in cases where the ticket involved multiple legs, and only a portion of the legs remains unused. In that case, the system may have additional software for calculating the residual value, or may query and outside service for the calculation. The calculation may be returned for storage with the other data.

In step 208, it is determined if the processing is successful/complete. If the processing is not successful (perhaps due to a formatting error), in step 210, an alert may be provided on the booking service side so that the ticket can be manually processed at a later time.

If the processing is successful, the method proceeds to step 212, in which the parsed and processed data is stored.

The data is preferably stored on the booking service side, rather than the GDS side. Because the GDS is an entity separate from the booking service, data on the GDS side is not as readily available to booking agents, since the GDS system must be contacted and an interface formed, and the format may not be conducive to the categorization and organization achieved in the present invention. Thus, the processed information is preferably stored in an exchange database (or databases) of the booking service. That includes databases controlled by and/or directly accessible by the POS tool of the booking service. Preferably, the database is tied to the POS tool such that an interface is provided in the POS tool, which interface has access to the database. Thus, when the POS tool is used to access the records of a client, the interface connected to the database automatically indicates that there is one or more unused tickets for that customer.

The database is preferably categorized and organized so that the relevant information can be automatically summoned when a booking tool retrieves information related to a particular traveler, a client (e.g., company at which the traveler is employed), etc. Such information should be able to be accessed by the traveler or client name, account number, or other identifying data.

In step 214, the unused tickets, the information for which is stored in the exchange database, is monitored. It is possible that the status of the unused ticket can change. Such a change is indicated in the GDS, which is the official record of the ticket. Such changes in status will not be automatically reflected in the records of the exchange database because the GDS does not automatically provide status updates. For instance, the passenger could apply the residual value of the ticket to another ticket, but not go through the booking service (e.g., the client could contact the airline directly or use another booking service). In that case, the records in the exchange database will not be up-to-date. To remedy this potential problem, the computer system of the booking service accesses the GDS periodically (preferably every few days) and checks on the status of the unused ticket stored in the exchange database. If there is a discrepancy between the ticket records of the GDS and the records of the exchange database, the exchange database is updated to reflect the most recent information from the GDS.

In step 216, the unused ticket data from the exchange database is provided to the POS tool. The POS tool can be designed in any number of ways to provide the relevant information. In preferred embodiments, an exchange GUI is provided in connection with the POS tool. The exchange GUI can take the form of a link in the GUI for the POS, a GUI box existing within the GUI of the POS tool, or some other form. The exchange GUI can indicate the mere existence of an unused ticket, leaving the booking agent to use the exchange GUI to find out more information. Alternatively, the exchange GUI can identify the particular unused ticket in the current screen so that the booking agent can determine its applicability to a new booking without further effort. As will be appreciated, the particular design of the GUI and mechanism for alerting the booking agent or customer to the existence of an unused ticket can take any number of forms, based on preferences of the designer and booking service. The present invention encompasses all of these various forms.

Thus, in future bookings, the booking agent and/or customer is, preferably, automatically provided with information concerning unused tickets that may be applied to future bookings with ease and effectiveness.

In alternative embodiments, the method of FIG. 2 may include an additional step of searching for “forgotten tickets.” For circumstances in which the booking service is not aware that the traveler canceled a non-refundable ticket and has an unused ticket available, there may be additional steps of accessing and searching the GDS for such unused tickets. Thus, even if the passenger does not inform the booking service that the ticket has been cancelled, the booking service can identify and monitor such tickets in a manner similar to when the cancellation is made though the booking agent. Again, it is preferred that the accessing and searching be performed using robotic jobs. In this situation, the ticket records at the GDS will not have processing instructions, so the robotic jobs preferably will search for unused tickets in accordance with set rules and specific processing instructions provided on the booking service side. As for examples of rules to be employed, the robotic jobs can be programmed to look for tickets that are still open (e.g., have at least one unused leg), and for which the date of travel is at least a set time in the past (e.g., at least three months ago). When such tickets are found, the robotic job can be provided with specific processing instructions for parsing data from the ticket records and updating the exchange database accordingly.

Typically, these alternative steps will be performed with respect to e-tickets, since paper tickets may not have sufficient records (e.g., an ETR) for which the robotic jobs can search.

In other embodiments, a step for entry of ticket data on the booking side (rather than retrieving the same from the GDS) may be included with the steps of FIG. 2, or in lieu of certain steps.

The exchange GUI may allow for entry of ticket data directly into the exchange repository. In that case, the method may include a data entry step at the time of cancellation of the non-refundable ticket. This step may be most helpful for paper tickets, since a paper ticket typically will not have an accompanying ETR at the GDS. This deficiency is accounted for in the method shown in FIG. 2 by providing necessary ticket data for the paper ticket in the remarks section of the PNR, so that the necessary data will be available to the robotic job when the ticket information is later processed. Thus, because there is no ETR for a paper ticket and the PNR may not have sufficient data for the updating of exchange database, there may be a data entry step in which the remarks section of the PNR is provided with the necessary information. In an alternative embodiment, rather than adding data to the remarks sections of the PNR at the GDS, the ticket information may be entered directly into the exchange database.

The entry of this data may be controlled by the booking agent, or alternatively, automatic routines may prompt, require or perform the entry of the necessary data. Such data may include the amount of the ticket, date of the ticket, residual value, and the like.

As will be appreciated, any amount of data can be entered through the exchange GUI, reducing or completely eliminating the need for the later accessing and processing of information at the GDS. The entry of the information in the exchange database can be manual, automated through computer routines, or some combination thereof. Of course, in most cases it will be preferable to obtain at least some of the data from the GDS because (1) ticketing agents are typically well versed in using the system, (2) much of the data is already stored there electronically, reducing the need for any manual data entry by the ticketing agent, and (3) there are existing software tools that aid in the processing of information from GDSs, reducing the need for development of new software for performing similar processes.

### IV. Example Implementations

The present invention (i.e., system 100, process 200, or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator, such as a booking agent. As discussed in some aspects above, no such capability of a human operator is necessary, or desirable in most cases, in any of the operations described herein which form part of the present invention. Rather, the operations may be machine operations. Useful machines for performing the operation of the present invention include general purpose digital computers or similar devices.

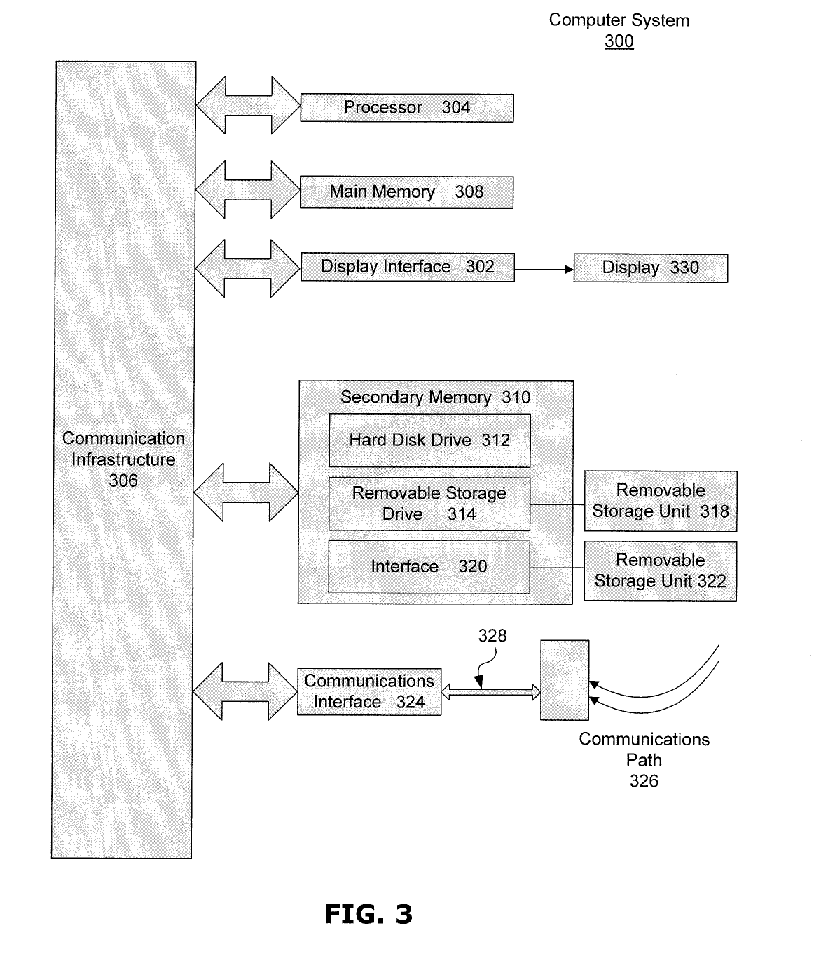

In fact, in one embodiment, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330. Examples of displayed information may be the GUIs for the POS tool and exchange.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals N28 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method for a ticketing service to identify and consolidate information on unused tickets, the method comprising the steps of:
(a) receiving a request from a client to cancel a ticket;
(b) processing the request received in the receiving step;
(c) extracting, from a record of the canceled ticket, data indicative of details of the canceled ticket including, at least, client identification information and ticket source identification information; and
(d) storing the extracted data in an electronic database,
wherein the database is linked to an electronic booking tool used by the ticketing service to process client requests, such that, when a record of the client is retrieved using the electronic booking tool, existence of the canceled ticket is identified to a user.

2. The method of claim 1, wherein the extracting step is performed, at least partially, by automated routines.

3. The method of claim 2, wherein, in the processing step, the canceled ticket is flagged for further processing at a global distribution system, and the extracting step comprises the sub-steps of:
(i) contacting the global distribution system;
(ii) identifying the canceled ticket flagged in the processing step;
(iii) retrieving at least one record of the ticket from the global distribution system; and
(iv) parsing data from the record of the ticket, and
wherein the storing step stores the parsed data in a database separate from the global distribution system.

4. The method of claim 2, wherein the processing step comprises the sub-steps of:
(i) accessing a record of the ticket at a global distribution system; and
(ii) providing in the record of the ticket, at the global distribution system, information concerning the processing to be performed during the extraction step and information concerning details of the ticket, and
wherein the extracting step comprises the sub-steps of:
(i) contacting the global distribution system;
(ii) accessing the record of the ticket in the global distribution system; and
(iii) parsing data from the record of the ticket based on the information provided in the providing step, and
wherein the storing step stores the parsed data in a database separate from the global distribution system.

5. The method of claim 2, further comprising a step of:
(e) displaying, in connection with the electronic booking tool, information concerning the identity of the canceled ticket automatically when a record of the client is retrieved using the electronic booking tool.

6. The method of claim 2, wherein the extracting step is performed later than and separate from the processing step.

7. A system for use by a ticketing system in identifying and consolidating information on unused tickets, the system comprising:
a booking tool through which a ticket agent processes ticket requests for a client, wherein the booking tool causes a ticket, canceled using the booking tool, to be identified and information in a record of that ticket to be extracted, including client identification information and ticket source information; and
a database storing the extracted information,
wherein the database is linked to the booking tool such that, when a record of the client is retrieved using the booking tool, existence of a ticket canceled for the client is identified to a user.

8. The system of claim 7, wherein the identification and extraction of information in a record of the ticket is performed, at least partially, by automated routines.

9. The system of claim 8, wherein the booking tool causes the canceled ticket to be flagged for further processing at a global distribution system, and the system further comprises a computer on the ticket agent side, wherein the computer:
(i) contacts the global distribution system;
(ii) identifies the canceled ticket flagged by the booking tool;
(iii) retrieves at least one record of the ticket from the global distribution system;
(iv) parses data from the record of the ticket; and
(v) stores the parsed data in a database separate from the global distribution system.

10. The system of claim 8, further comprising a computer, on the ticket agent side, wherein the booking tool accesses a record of the ticket at a global distribution system and provides in the record of the ticket at the global distribution system (1) information concerning processing to be performed by the computer and (2) information concerning details of the ticket, and wherein the computer:
(i) contacts the global distribution system;
(ii) accesses the record of the ticket in the global distribution system;
(iii) parses data from the record of the ticket based on the information provided in the record of the ticket by the booking tool; and
(iv) stores the parsed data in a database separate from the global distribution system.

11. The system of claim 8, further comprising a display that displays, in connection with the electronic booking tool, information concerning the identity of the canceled ticket automatically when a record of the client is retrieved using the electronic booking tool.

12. A computer program product comprising a computer usable medium having control logic stored therein for causing a computer to perform a method of identifying and consolidating information on unused tickets, the control logic comprising:
first computer readable program code means for causing the computer to receive a request from a client to cancel a ticket;
second computer readable program code means for causing the computer to process the request to cancel the ticket;
third computer readable program code means for causing the computer to extract from a record of the canceled ticket data indicative of details of the canceled ticket including, at least, client identification information and ticket source identification information; and
fourth computer readable program code means for causing the computer to store the extracted data in an electronic database,
wherein the database is linked to an electronic booking tool used by a ticketing service to process client requests, such that, when a record of the client is retrieved using the electronic booking tool, existence of the canceled ticket is identified to a user.

13. The computer program product of claim 12, wherein the extraction is performed, at least partially, by automated routines.

14. The computer program product of claim 13, further comprising fifth computer readable program code means for causing the computer to flag the canceled ticket for further processing, at a global distribution system, wherein the extraction comprises:
(i) contacting the global distribution system;
(ii) identifying the canceled ticket flagged by the fifth computer readable program code means;
(iii) retrieving at least one record of the ticket from the global distribution system;
(iv) parsing data from the record of the ticket; and
(v) storing the parsed data in a database separate from the global distribution system.

15. The computer program product of claim 13, wherein the second computer readable program code means causes the computer to:
(i) access a record of the ticket at a global distribution system; and
(ii) provide in a record of the ticket at the global distribution system information concerning the processing to be performed during the extraction and information concerning details of the ticket, and
wherein the third computer readable program code means causes the computer to:
(i) contact the global distribution system;
(ii) access the record of the ticket in the global distribution system;
(iii) parse data from the record of the ticket based on the information provided in connection with the second computer readable program code means; and
(iv) store the parsed data in a database separate from the global distribution system.

16. The computer program product of claim 13, further comprising fifth computer readable program code means for causing the computer to display, in connection with the electronic booking tool, information concerning the identity of the canceled ticket automatically when a record of the client is retrieved using the electronic booking tool.

17. The computer program product of claim 13, wherein the extraction is performed later than and separate from the processing.
